(19) United States
(12) Patent Application Publication
(10) Pub. No.: US 2014/0172640 A1
(43) Pub. Date: Jun. 19, 2014

(54) AUGMENTED REALITY SHOPPING GAME

(71) Applicants: Stuart Argue, Palo Alto, CA (US); Anthony Emile, San Francisco, CA (US)

(72) Inventors: Stuart Argue, Palo Alto, CA (US); Anthony Emile, San Francisco, CA (US)

(73) Assignee: Wal-Mart Stores, Inc., Bentonville, AR (US)

(21) Appl. No.: 13/720,390

(22) Filed: Dec. 19, 2012

(51) Int. Cl. G06Q 30/06

(52) U.S. Cl. CPC G06Q 30/0641
USPC 705/26.61

(57) ABSTRACT

Augmented reality programs permit graphics to be projected upon a view. A scavenger hunt game can be operated within a retail store utilizing a processing device operating an augmented reality program. The game includes receiving, at a processing device, a list of objects being sought, each object indicating one of a product being sold by the store or a task to be performed within the store. The game further includes, for each object being sought, determining an in-store location for the object, displaying though the augmented reality program in-store navigational instructions for each object being sought based upon the in-store location for the object, and confirming, at the processing device, retrieval of each object being sought.

### BACKGROUND INFORMATION

1. Field of the Disclosure

The present invention relates generally to a software application for use on a mobile computerized device. In particular, examples of the present invention are related to a software application providing entertainment for a child accompanying an adult to a retail store.

2. Background

Augmented reality includes software applications that superimpose computer generated images upon a view of the real world. In one embodiment, augmented reality can be operated upon a processing device or a portable computerized device embodied as a pair of eyeglasses configured to project graphical images upon the transparent or nearly transparent lens or lenses of the eyeglasses, such that the viewer sees the graphical images in the context of actual objects visible through the lenses. In another embodiment, augmented reality can be operated upon a smart-phone, a tablet computer, or other similar portable device. A camera device configured to capture a series of images from an area surrounding the portable device captures a video feed, the video feed can be shown upon a display of the device, and graphical images can be superimposed upon the video feed. The camera on a portable computerized device can display in real-time a view proximate to the device, and an augmented reality program operating upon the device can enhance the display of the view with additional graphics.

Augmented reality can provide computer generated graphical images superimposed upon a visual scene of an area proximate to the viewer. In combination with image recognition and programming permitting identification of features in a view, graphical images can be projected to identify an object of interest in the view. Graphical images can be configured to interact in an amusing way or otherwise entertain the viewer. Graphical images can provide instruction. By superimposing images upon a view of objects in the real world, the experience of the viewer can be enhanced with information, entertainment, or other graphical content.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 illustrates an exemplary view of an aisle in a retail store with an augmented reality program projecting graphics upon the view, the projected graphics enabling a user to play a scavenger hunt game in the retail store, according to some embodiments of the present disclosure;

FIG. 2 is a schematic illustrating an exemplary portable computerized device in communication with an exemplary store product index server according to some embodiments of the disclosure;

FIG. 3 is a schematic illustrating an exemplary pair of eyeglasses configured to operate an augmented reality program according to some embodiments of the disclosure;

FIG. 4 is a schematic illustrating example components of the mobile computing device of FIG. 2;

FIG. 5 is a schematic illustrating an exemplary store product index server according to some embodiments of the disclosure;

FIGS. 6A and 6B are schematics illustrating an exemplary portable computerized device configured to operate as a controller device for a scavenger hunt game according to some embodiments of the disclosure;

FIG. 6A is a schematic illustrating the portable computerized device enabling a user to configure a shopping list and assign items on the shopping list to be assigned to objects lists for use in the game;

FIG. 6B is a schematic illustrating the portable computerized device enabling a user to monitor a plurality of other users during operation of the game, to monitor progress of items from the shopping list being acquired, and to communicate with the other users as desired;

FIG. 7 is a schematic illustrating an exemplary controller device and a plurality of exemplary playing devices in communication with a store product index server according to some embodiments of the disclosure;

FIG. 8 is a flowchart illustrating an exemplary process to operate a scavenger hunt game with two users according to some embodiments of the disclosure; and

FIG. 9 is a flowchart illustrating exemplary operation of a playing device guiding a user through a scavenger hunt game according to some embodiments of the disclosure; and

FIG. 10 is a block diagram illustrating exemplary components of the portable computerized device according to some embodiments of the disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Adults and caretakers of children frequent retail stores with children. Children can become bored or restless while following an adult through a store, making the tasks required of the adult in the store more difficult. In other settings, games or competitions can be used to entertain children. Numerous games are known to keep a child's interests. One embodiment of such a game is scavenger hunt wherein the child is tasked to find a list of objects hidden or objects that must be sought out. In one embodiment of a scavenger hunt, an observer with knowledge of the location of a hidden object provides feedback to the child seeking the object, for example, proclaiming “warmer” to the child as the child gets relatively closer to the object and proclaiming “colder” to the child as the child gets relatively further away from the object. In another embodiment of a scavenger hunt, a “treasure map” can be provided. The treasure map can be indexed to objects in the real world, for example, with a visible object in the real world being specifically shown on the map. In another embodiment, objects or features to index the map can be provided as hints or tasks can be required of the participant before features to index the map are provided. In place of a map, instructions can be provided to the child seeking the object being sought. Such an instruction can include “Walk ten steps forward and turn left.” A number of embodiments of scavenger hunt games are envisioned, and the disclosure is not intended to be limited to the particular examples provided herein.

An augmented reality program can be configured to entertain a child or children in a store. In one embodiment, a scavenger hunt can be provided, with graphical images presented to the child as instructions to perform the scavenger hunt. The objects sought in the scavenger hunt can be objects from the accompanying adult's shopping list, and a requirement to complete a task in the game can be to bring the object back to the adult. In this way, the game can facilitate the adult completing the task of shopping while entertaining the child. Items selected as objects can be designated for a particular child, for example, if one child enjoys macaroni and cheese, the adult can designate macaroni and cheese as an object to be sought for that child. Additionally, tasks can be added to a scavenger hunt list, such as asking customer service when holiday goods will be available at the store. Embodiments disclosed herein include references to children, however, it will be appreciated that embodiments are envisioned with adults as users for the methods disclosed.

According to one exemplary embodiment, an augmented reality program for entertaining children in a retail store can include providing an object being sought or a list of objects being sought to a child and operating a scavenger hunt game within the store wherein the child is provided navigational instructions to seek out the object being sought. The game can be operated upon a portable computerized device such as eyeglasses configured to project images in the view of the wearer or other portable computerized device such as a smart-phone, a tablet computer, or a gaming system. The portable computerized device preferably includes a capability to monitor a location of the device and a capability to communicate wirelessly. Each child paying the game can have a playing device. An adult accompanying the child or children to the store can have a controlling device capable of permitting the adult to monitor the children's progress or location, communicate with the children, and/or control parameters of the game. Further, the controlling device can have a display of the shopping list with feedback regarding which items have been assigned, which items have been located by the children, and a separate list for the adult to acquire while the children are playing the game. The playing devices can also include a display or indication to the location of the adult and/or the location of the adult's shopping cart so that the children can deliver objects to the cart or easily find the adult. Any of the portable computerized devices can include a playing mode, wherein directions and animations associated with the game are displayed, and a wrap-up mode, wherein the children are prompted to efficiently return to the adult and/or the adult is provided with prompts to communicate with and quickly find the children.

Operation of a scavenger hunt game as disclosed herein includes a computerized method. Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied as any tangible medium of expression having computer-usable program code embodied in the medium.

Object selection from an adult's shopping list can be performed manually, with the adult assigning objects or tasks to each child. In another embodiment, the augmented reality program can automatically assign objects or tasks, for example, based upon the age, gender, preferences, etc. of the particular child. In one example, products that can be dropped and cause problems, such as a gallon of milk which can rupture and cause a large spill, can be limited for selection for a child of at least a minimum age.

A number of methods are known to geographically locate a device. According to one embodiment, a real-time locating system (RTLS) can be used to identify a location of a person or an object. Such an RTLS can include a position sensor, for example, communicating with infrastructure devices by wireless signals. Additionally or alternatively, accelerometers can also be used to track movement. In one embodiment, a global positioning system (GPS) can be used to augment a measurement of a location of a device. A number of methods are known to locate and track movement of a device within a store, and the disclosure is not intended to be limited to the particular exemplary methods disclosed herein.

According to one embodiment, the adult accompanying the children to the store can be in control of a number of parameters of the augmented reality program. In addition to controlling which child gets which objects to find and/or retrieve, the adult can specify where in the store a child should be allowed to travel, for example, by selecting a number of aisles in the store in which the child should remain and specifying that the child and the adult should be alerted if the child wanders outside of the permitted area. The adult can control operation of the game, for example, providing extra hints if the child gets frustrated or ending the game if the adult wants to proceed to the checkout. Audio or visual communication between the adult and the children can be provided based upon an input request from either the adult or the children, for example, permitting the adult to check on a child or permitting a child to ask a question of the adult regarding an object or the location of the adult. A number of parameters or details of operation of the augmented reality program can be controlled by the adult, and the disclosure is not intended to be limited to the particular examples provided herein.

Shopping lists can be entered remotely, for example, by an adult entering the list into a portable computerized device that will be brought to the store during the shipping trip. Alternatively, shopping lists can be entered remotely by logging into the store's website and entering the list through a registered user account such that the list is available to the user can access the list once within the store. In another embodiment, the adult can enter items from a list within the store. Entry of a list can be performed by entering text, by selecting items from a searchable list, by voice recognition, or by any method known in the art for data entry. Favorite shopping lists can be saved and reused. Objects can be added to the list during a shopping trip, for example, by the adult in the store adding items to his or her portable computerized device.

In one embodiment, arrival of a child at a particular product included as a sought object upon a scavenger hunt list can include directing the child to acquire one or more of the object from the goods upon the shelf. In another embodiment, the child can be directed to scan a product index such as a 2D barcode or indicating marks that can be recognized from a picture of a label of the product. This acquisition of information from the product or imaging of a product index can be used to compare the index to an expected index for the object being sought and mark the object on a scavenger list as being achieved or completed based upon the comparing. In another embodiment, the scanning of the item can create a prompt to the adult, permitting the adult to review the candidate item, the price of the item, the container size of the item, or other details, and the adult can approve, disapprove, or provide corrective feedback to the child, for example, telling the child to get the item next to the candidate item marked as “Low Sodium.” In addition to items on the list provided by the adult, the child can scan an item desired by the child, and the adult can approve or disapprove of the item through similar feedback. According to another embodiment, objects or tasks on the scavenger list can be completed simply by the child reaching a particular location, such as reaching a location in front of a particular product, in order to prevent the child from disrupting the alignment of objects on the shelves. Tasks upon the scavenger hunt list can be achieved or completed by the child getting within a specific range, for example, within ten feet, of an object.

In another embodiment, objects to be sought or tasks upon a scavenger hunt list can be destinations for the child to reach rather than physical goods in the store. Destinations upon a scavenger hunt list can include lower traffic areas of the store wherein a child is unlikely to bother other shoppers instead of directing the children to further congest an already busy portion of the store.

The augmented reality program can be operated on hardware owned and operated by the retail store. Customers can request use of the system and return the system at the end of shopping. Such a configuration permits the store to operate memberships, advertising campaigns, provide recommended items based upon demographics or collected data on the users, or provide scavenger hunt patterns that create desired customer traffic patterns within the store. According to another embodiment, the augmented reality program can be operated upon hardware owned or in the possession of the customer.

The methods disclosed herein can be operated through software published by the retail store. Store control of the augmented reality program permits the store to control themes of the animated game details, for example, operating game details and in-game rewards based upon an animated movie for which the store has a special display of associated toys. Further, store control of the augmented reality program permits the store to operate rules of the game that discourage children from acting poorly, for example, discouraging running, horseplay, or preventing too many children from aggregating in a particular area.

Software operating the augmented reality program can published or otherwise being made available by the store for use upon hardware owned by the customers. Store control of the program provides for accurate locations of items within the store being available to users of the program. The store is in the best position to provide and maintain an accurate list of products and product locations within the store. Installation of the augmented reality program can be achieved by making the necessary software available for download from a website, purchase in known software formats, such as delivery by compact disk or by flash drive, or by any other known methods of software delivery and installation.

Building and maintaining a database for locating products or specific locations within a store can be accomplished through a number of methods. For example, a store can maintain such a location database for assisting store personnel in stocking and auditing the store inventory. In such an event, the already existing database could be used for the game, or a copy of the database could be made periodically, and the copy used to operate the game. In another exemplary embodiment, a store wishing to build a database for the purpose of implementing the game could use a dedicated scanner keyed to the store product index server, scan in the inventory of the store, and implement policies requiring that any changes to store inventory be scanned in as part of the change. Additionally or alternatively, a first game mode or a learning game mode could be used wherein a product's in-store location is not known in the database, the first mode actually relying upon the children to find the products, and as children seek out the products, the database can be updated. Once a threshold number of products are located in the database, a second game mode or an operational game mode can be operated wherein the game is capable of directing children to the products as needed.

The augmented reality program can be operated on devices owned by the customer, with the augmented reality program published or otherwise being made available by a third party publisher. In such an embodiment, the locations of items within a store are less known or may only be available for participating stores. However, a scavenger hunt can still be run based upon the children acquiring items within the store and scanning the 2D barcodes or the labels of objects within the store to complete assigned tasks for the scavenger hunt. Additionally, the augmented reality program can still permit the adult to monitor the locations of the children and communicate with the children as the adult shops in the store.

Rules or parameters for the augmented reality program can be operated based upon the age of the participants. For example, young children too young to be separated from a parent can be assigned objects to his or her scavenger hunt list within a certain distance of the parent's current location or located in the same aisle as the parent. Older children can be assigned objects throughout the entire store. A maximum weight of objects to be assigned can be set based upon age or the preference of the adult. Rules can be designated based upon safety guidelines, for example, requiring the adult to shop for items such as raw chicken or medication which are not ideal for young children to handle.

Rules for the augmented reality program can be provided to prevent children from acting in an undesirable manner. Accelerometers or location information can be used to prevent a child from running. Penalties can include in-game penalties (losing in-game points for running) or alerts to the parent regarding the behavior of the child. In-game rewards can be assigned based upon the child saying please or thank you to a store employee.

The augmented reality program can include rules to keep the kids in certain parts of the store and away from exits. Alerts to adult and store personnel can be generated if a child gets close to a restricted area.

Operation of the game can take many different embodiments. A single child can get points for every object acquired and additional points for delivering the object back to the adult's shopping cart. In the alternative, the child can get rewards for bringing back a certain number of objects. For example, pieces of an in-game puzzle can be unlocked for every object successfully delivered to the shopping cart, and once the entire puzzle is unlocked, the child can play a side-game solving the puzzle. In another embodiment, a drawing to be colored in can be emailed or otherwise delivered for the child based upon completing a particular challenge. In another embodiment, a threshold score can earn rewards from the store such as an achievement sticker or a discount coupon at an in-store restaurant. An accumulated score over time can be kept for a particular child, and a cumulative reward can be earned by the child for playing the game over time.

The graphics displayed by the portable computerized device can take many forms. Graphics can be generated to indicate to an object being sought on a store shelf to aid the child in selecting the correct product. Trademarks or logos can be displayed to aid the child is selecting the correct product. If the product includes an animated logo or a cartoon character as part of a marketing campaign, graphics can be projected with the associated animation to entertain the child and foster brand loyalty. A child, accustomed to seeing an entertaining graphic when retrieving a certain brand of cereal, could request that the cereal be on the child's object list every trip.

Graphics can be generated to show a pattern on the floor in front of an item being sought to similarly aid the child in selecting the correct product. A graphic can be generated to show that the child has selected the correct or an incorrect product. A graphic can be generated to communicate “warmer” or “colder” in association with a scavenger hunt configured to guide the child to an object. Arrows can be generated, for example, at the request of a hint by the child, and used to point the child in the right direction or to direct the child back to the adult's shopping cart. Audio messages can be used to guide the child, provide feedback to the child as the child gets closer or further from the intended object, or provide negative feedback if the child runs or gets close to leaving an area selected by the adult within which the child is expected to remain.

Graphics and accompanying audio can be used to provide rewards for the child. Rewards can include text, graphics, and audio with images of fireworks, smiling characters, music, or any other image or cut-scene that provides positive feedback to the child operating the game. Any number of in-game stories could be told, for example, with each object being sought representing buried pirate treasure or jewels from a princess' lost necklace. The in-game display can operate selectable themes which can be presented to a child upon start-up or pre-selected based upon the age and gender of the child. Of three children accompanying an adult, one can be playing a game based upon unicorns, another can be playing a game with a baseball theme, and the third can be playing a game based upon oceanic fauna. Each controller can be configured to operate a distinct theme during a common game. For example, of two children playing the game, one child's game could have one theme counting down to a threshold victory based upon both children's scores, and the other child could have a second theme planting flowers that grow more ornate based upon both children's scores. A number of exemplary game structures and themes are envisioned, and the disclosure is not intended to be limited to the particular exemplary embodiments provided herein.

Hardware and software configurations of the systems disclosed herein can take many different embodiments. An augmented reality program can be installed upon a portable computerized device. In another embodiment, a portable computerized device can include an augmented reality program configured permanently to the hardware of the device. In one embodiment, a single store product index server can be utilized remotely to provide product locations in a plurality of stores, with communication of necessary information being transferred over a communications network. In another embodiment, a single remotely operated store product index server can be used to provide product locations for a single store. In one embodiment, a remote server can be used as a store product index server, and a second, local, in-store server can be used to permit local wireless communication between customers and the local server. In another embodiment, a store product index server can be local to a store. Communication between portable computerized devices and a store product index server can be over a cellular network, over a local network operated by the store, or by other communications methods known in the art.

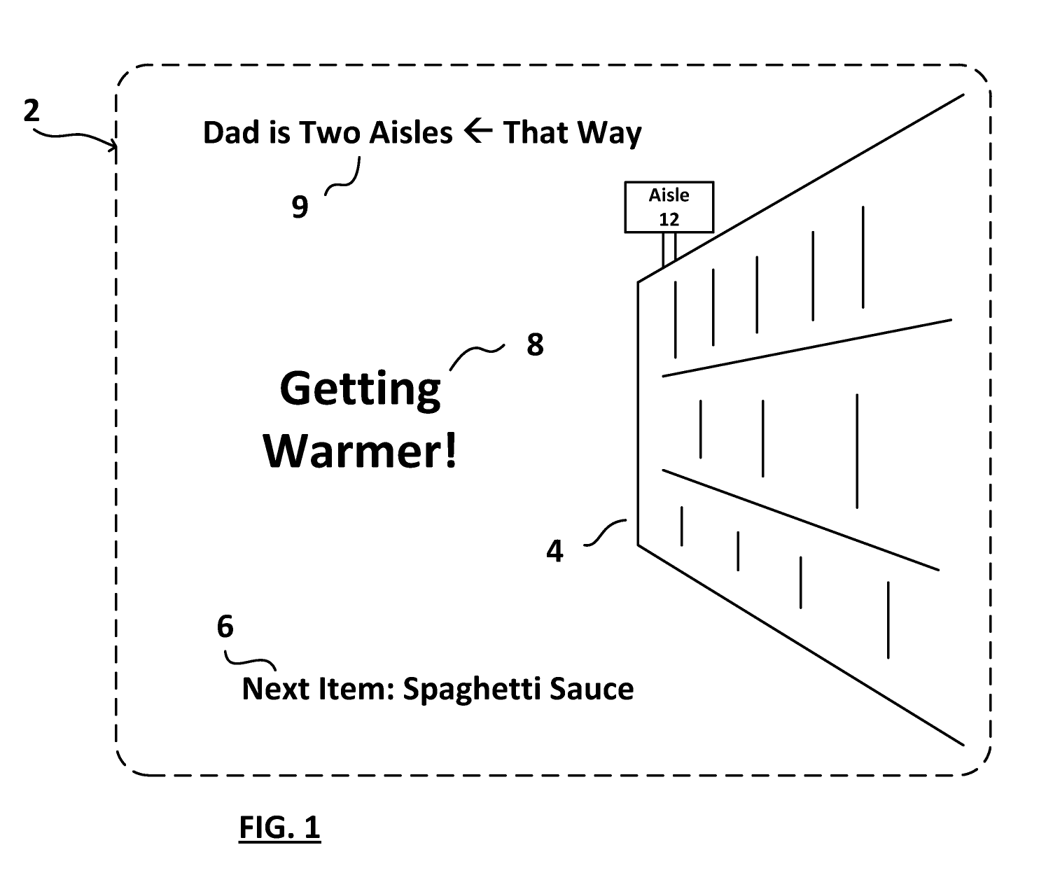

FIG. 1 illustrates an exemplary view of an aisle in a retail store with an augmented reality program projecting graphics upon the view, the projected graphics enabling a child to play a scavenger hunt game in the retail store. View 2 includes a view of the retail store including product shelves 4. View 2 further includes text messages 6, 8, and 9 configured to operation of the game. Message 6 is an object being sought message, identifying the current object being sought for the child. The object of message 6 can be vague, permitting the child to use some discretion to pick “a cereal you like” or “a snack for you to bring to school.” The object of message 6 can be specific, specifying a particular brand and package size required to fulfill the object being sought. Message 6 can include logos, an image of what the correct package looks like, or other graphics to aid in correct identification of a product as the object being sought. Message 8 is a navigation instruction, providing feedback to the child enabling the child to get closer to and find the product within the store. In the particular embodiment of FIG. 1, the navigation instruction tells the child “Getting Warmer!” or, conversely, “Getting Colder.” depending upon whether the child is moving in the right direction to get to the current object being sought. A number of embodiments for providing navigation instructions to the child are envisioned, including arrows, non-directional ranges, or hints, and the disclosure is not intended to be limited to the particular examples provided herein. View 2 also includes an optional adult locating message 9, providing a child with an easy direction to get back to the cart or to find the adult that they came to the store with.

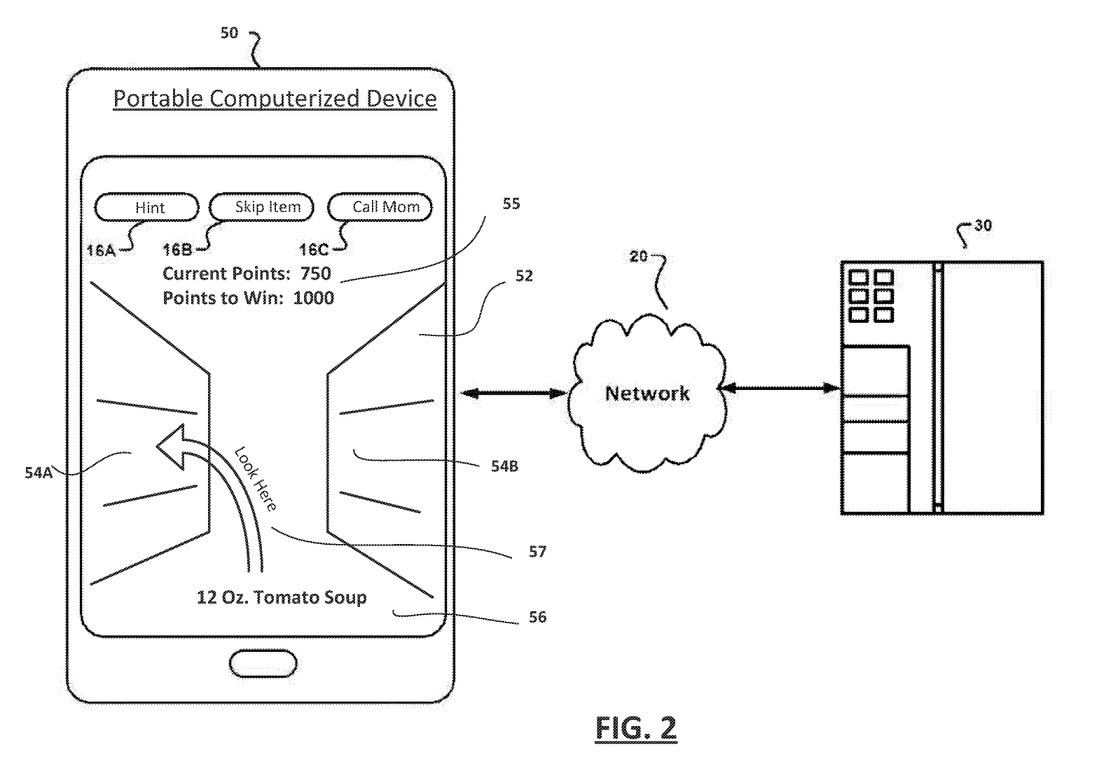

FIG. 2 is a schematic illustrating an exemplary portable computerized device in communication with an exemplary store product index server. Portable computerized device 50 includes a smart-phone or similar device capable of communicating over a wireless network. Store product index server 30 is illustrated, including programming configured to provide in-store locations of products or locations to travel to that can be assigned as tasks. Either device 50 or server 30 can include an in-store navigation instruction module including programming to provide directions to a child to get to an in-store location based upon the location of an object being sought and a current location of device 50. Network 20 is provided to permit communication between device 50 and server 30.

A view of the store is provided upon display 52 of device 50. The view of the store including product shelves 54A and 54B can be acquired through data generated by a camera device provided upon device 50. Text and other graphics can be superimposed over the view through operation of an augmented reality program upon device 50. An object being sought message 56 identifies for child a current object being sought. A location of device 50 provided by a real-time locating system (RTLS) and/or other methods and image recognition programming within device 50 can be utilized according to the methods disclosed herein to provide graphics leading a child to a particular item on a shelf. Navigation instruction 57 is provided including an arrow and textual information telling the child where to look for the object being sought. Graphic buttons 16A, 16B, and 16C are provided as a graphical user interface (GUI) for the child, permitting easy access of game or communication functions that the child might want to activate. Exemplary button 16A permits the child to ask for a hint to help the child find the object being sought. Hints can include providing more descriptive arrows, more descriptive text, or connecting the child with either the adult or with a store employee to provide additional details regarding the location of the object. Exemplary button 16B permits the child to skip the current item being sought, for example, if the item is too hard to reach or lift. Exemplary button 16C permits the child to quickly contact a parent. Game detail message 55 is provided, in this exemplary embodiment, including a tally of current points achieved by the child and a total number of points required to win the game.

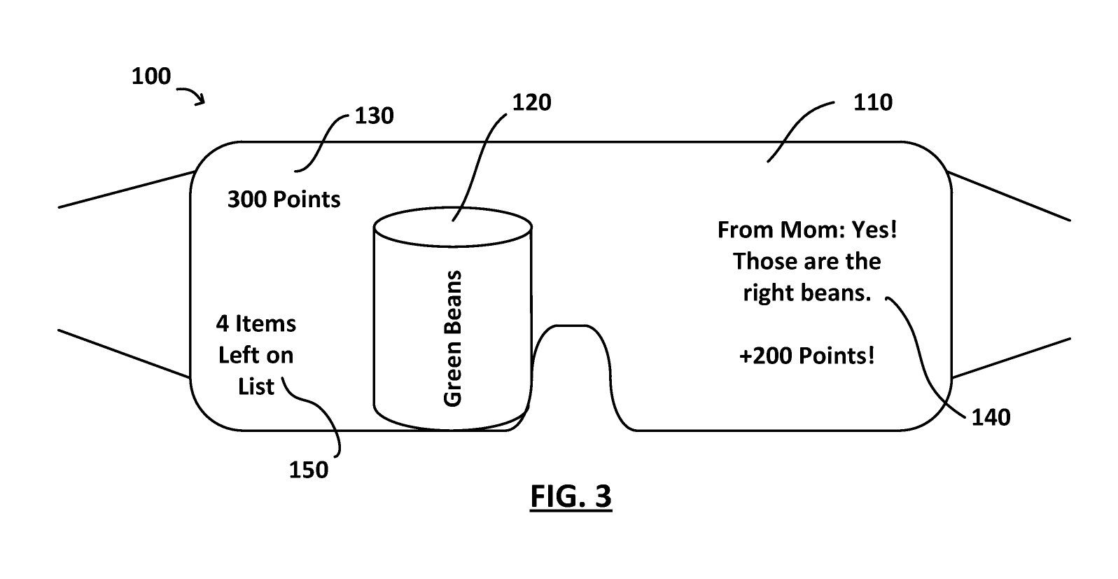

FIG. 3 is a schematic illustrating an exemplary pair of eyeglasses configured to operate an augmented reality program. Configuration 100 includes a portable computerized device embodied as eyeglasses 110 configured to project graphics upon a view visible through the eyeglasses. Object 120 including a can of green beans is illustrated. Object 120 can be a candidate object that the child has selected from the shelf. According to one embodiment, image recognition programming can be used to compare a candidate item to an object being sought. In the exemplary embodiment of FIG. 3, message 140 illustrates manual approval or disapproval of a candidate object by the adult, for example, by the adult operating a controller device. Game detail message 130 provides a point tally to the child, and game detail message 150 provides the child with a summary of progress through the assigned object list.

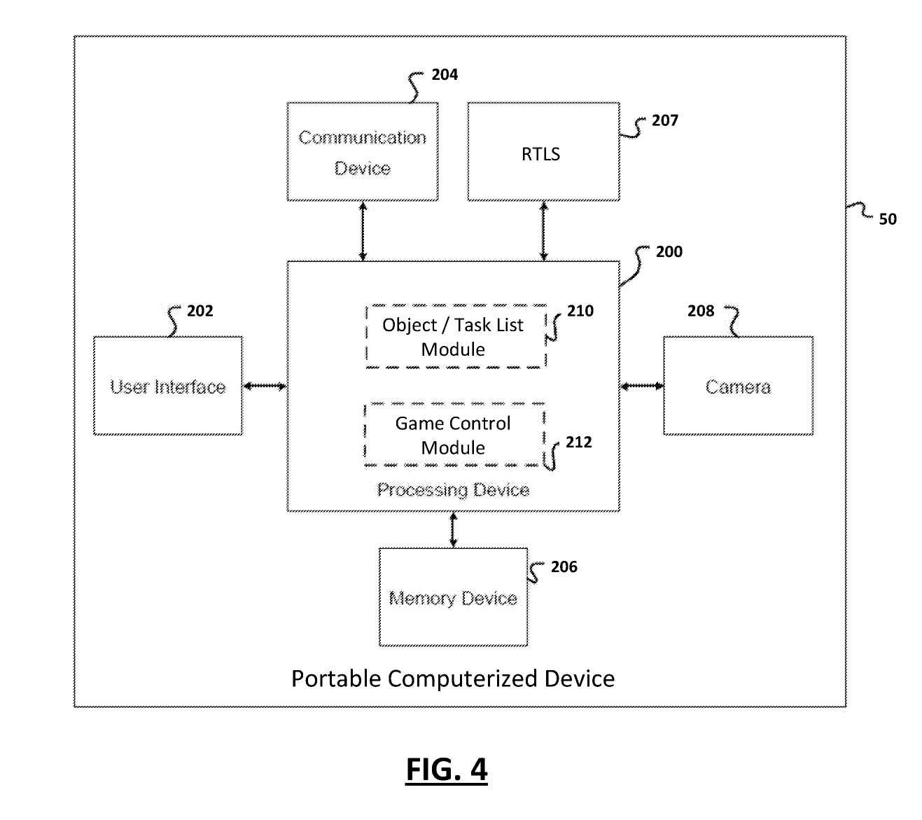

FIG. 4 is a schematic illustrating example components of the mobile computing device of FIG. 2. The exemplary portable computerized device 50 includes a processing device 200, a user interface 202, a communication device 204, a memory device 206, an RTLS system 207, and a camera 208. It is noted that the portable computerized device 50 can include other components and some of the components are not required.

The processing device 200 can include memory, e.g., read only memory (ROM) and random access memory (RAM), storing processor-executable memory (ROM) and random access memory (RAM), storing processor-executable instructions and one or more processors that execute the processor-executable instructions. In embodiments where the processing device 200 includes two or more processors, the processors can operate in a parallel or distributed manner. In the illustrative embodiment, the processing device 200 can execute the operating system of the portable computerized device 50. In the illustrative embodiment, the processing device 200 also executes an object/task list module 210 and a game control module 212, which are described in greater detail below.

The user interface 202 is a device that allows a user to interact with the portable computerized device 50. While one user interface 202 is shown, the term “user interface” can include, but is not limited to, a touch screen, a physical keyboard, a mouse, a microphone, and/or a speaker. The communication device 204 is a device that allows the mobile computing device 10 to communicate with another device, e.g., the store product index server 30, via the network 20. The communication device 204 can include one or more wireless transceivers for performing wireless communication and/or one or more communication ports for performing wired communication. The memory device 206 is a device that stores data generated or received by the portable computerized device 50. The memory device 206 can include, but is not limited to, a hard disc drive, an optical disc drive, and/or a flash memory drive.

The RTLS 207 determines a location of the portable computerized device 50 through wireless communication. It should be appreciated that while RTLS207 is shown, any other suitable component for determining the location of the portable computerized device 50 can be implemented.

The camera 208 is a digital camera that captures a digital photograph. The camera 208 receives an instruction to capture an image, captures an image of an object, i.e., a handwritten shopping list, and outputs the digital photograph. The digital photograph can be a bitmap file. The bitmap file can be a bitmap, a JPEG, a GIF, or any other suitably formatted file. The camera 208 can receive the instruction to capture the image from the processing device 200 and can output the digital photograph to the processing device 200.

Object/task list module 210 receives a list of objects to be sought and/or locations within the store that the child is required to navigate to or acquire to complete the game. Object/task list module 210 can include programming to compare images from camera 208 to an expected image to confirm achievement of an in-game goal. Such an image can be based upon an appearance of packaging on a candidate object or details from a photo of a 2D barcode located to the product. In another embodiment, object/task list module 210 can compare a current location of device 50 to a desired location for a task or object being sought and confirm achievement of an in-game goal based upon the comparison.

Game control module 212 can include programming including rules of the game being played and routines accomplishing the prompting and monitoring operations required to operate the game. Modules 210 and 212 are provided including non-exhaustive functions that would be required in device 50 to operate a game as disclosed herein. The disclosure assumes that device 50 and processing device 200 further include programming known in the art to enable operation of games, themes, graphic generation, and the other features of the disclosure detailed herein.

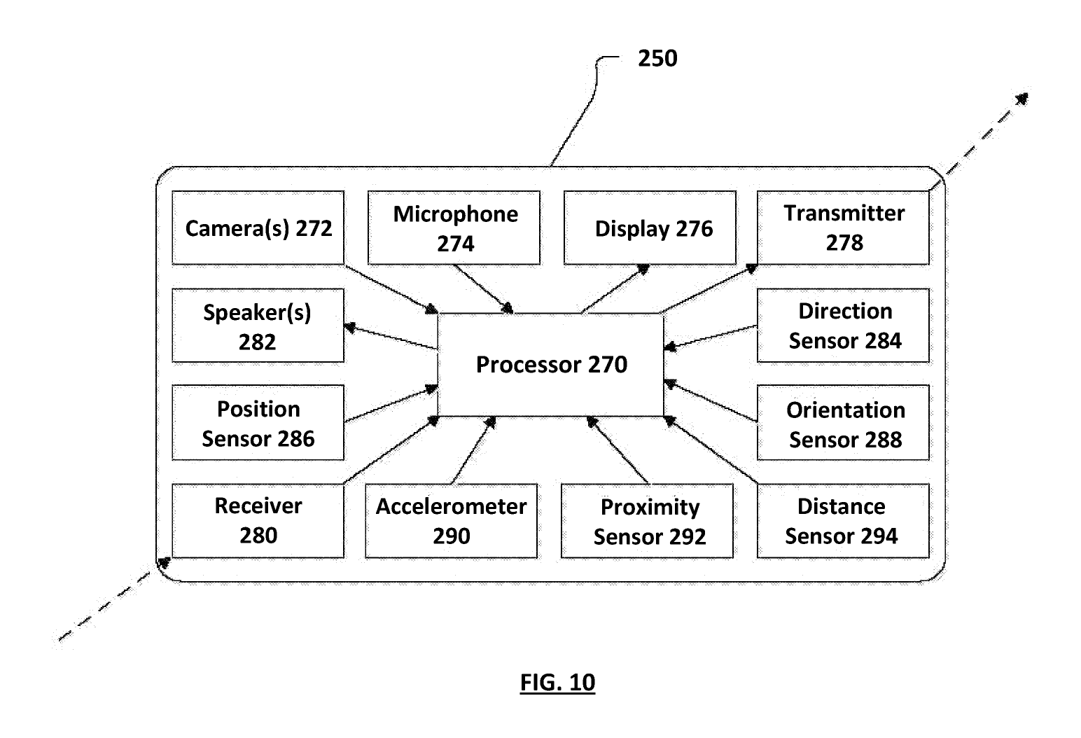

FIG. 10 is a block diagram illustrating exemplary components of the portable computerized device 250. Portable computerized device 250 can include exemplary eyeglasses attached to a head mount unit configured to display graphics in a view of a user. The portable computerized device can include a processor 270, one or more cameras 272, a microphone 274, a display 276, a transmitter 278, a receiver 280, one or more speakers 282, a direction sensor 284, a position sensor 286, an orientation sensor 288, an accelerometer 290, a proximity sensor 292, and a distance sensor 294.

The processor 270 can be operable to receive signals generated by the other components of the portable computerized device 250. The processor 270 can also be operable to control the other components of the portable computerized device 250. The processor 270 can also be operable to process signals received by a device configured as a head mount unit. While one processor 270 is illustrated, it should be appreciated that the term “processor” can include two or more processors that operate in an individual or distributed manner.

The a head mount unit can include one or more cameras 272. Each camera 272 can be configured to generate a video signal. One of the cameras 272 can be oriented to generate a video signal that corresponds to the field of view of the consumer wearing the head mount unit. Each camera 272 can be operable to capture single images and/or video and to generate a video signal based thereon. The video signal may be representative of the field of view of the consumer wearing the head mount unit.

In some embodiments of the disclosure, cameras 272 may be a plurality of forward-facing cameras 272. In such embodiments, the orientation of cameras 272 can be known and the respective video signals can be processed to triangulate an object with both video signals. This processing can be applied to determine the distance that the consumer is spaced from the object. Determining the distance that the consumer is spaced from the object can be executed by the processor 270 or by a commerce server using known distance calculation techniques.

Processing of the one or more, forward-facing video signals can also be applied to determine the identity of the object. Determining the identity of the object, such as the identity of a product in the retail store, can be executed by the processor 270 or by the commerce server. If the processing is executed by the commerce server, the processor 270 can modify the video signals to limit the transmission of data back to commerce server. For example, the video signal can be parsed and one or more image files can be transmitted to the commerce server instead of a live video feed. Further, the video can be modified from color to black and white to further reduce transmission load and/or ease the burden of processing for either the processor 270 or the commerce server.

In some embodiments of the present disclosure, the cameras 272 can include one or more inwardly-facing cameras directed toward the consumer's eyes. A video signal revealing the consumer's eyes can be processed using eye tracking techniques to determine the direction that the consumer is viewing. In one example, a video signal from an inwardly-facing camera can be correlated with one or more forward-facing video signals to determine the object the consumer is viewing.

The microphone 274 can be configured to generate an audio signal that corresponds to sound generated by and/or proximate to the consumer. The audio signal can be processed by the processor 270 or by the commerce server. For example, verbal signals can be processed by the commerce server such as “this product appears interesting.” Such audio signals can be correlated to the video recording.

The display 276 can be positioned within the consumer's field of view. Video content can be shown to the consumer with the display 276. The display 282 can be configured to display text, graphics, images, illustrations and any other video signals to the consumer. The display 276 can be a transparent when not in use and partially transparent when in use to minimize the obstruction of the consumer's field of view through the display 276.

The transmitter 278 can be configured to transmit signals generated by the other components of the portable computerized device 250 from the head mount unit. The processor 270 can direct signals generated by components of the portable computerized device 250 to the commerce sever through the transmitter 278. The transmitter 278 can be an electrical communication element within the processor 270. In one example, the processor 270 is operable to direct the video and audio signals to the transmitter 278 and the transmitter 278 is operable to transmit the video signal and/or audio signal from the head mount unit, such as to the commerce server through a communications network.

The receiver 280 can be configured to receive signals and direct signals that are received to the processor 270 for further processing. The receiver 280 can be operable to receive transmissions from the network and then communicate the transmissions to the processor 270. The receiver 280 can be an electrical communication element within the processor 270. In some embodiments of the present disclosure, the receiver 280 and the transmitter 278 can be an integral unit.

The transmitter 278 and receiver 280 can communicate over a Wi-Fi network, allowing the head mount device to exchange data wirelessly (using radio waves) over a computer network, including high-speed Internet connections. The transmitter 278 and receiver 280 can also apply Bluetooth® standards for exchanging data over short distances by using short-wavelength radio transmissions, and thus creating personal area network (PAN). The transmitter 278 and receiver 280 can also apply 3G or 4G, which is defined by the International Mobile Telecommunications-2000 (IMT-2000) specifications promulgated by the International Telecommunication Union.

The head mount unit can include one or more speakers 282. Each speaker 282 can be configured to emit sounds, messages, information, and any other audio signal to the consumer. The speaker 282 can be positioned within the consumer's range of hearing. Audio content transmitted by the commerce server can be played for the consumer through the speaker 282. The receiver 280 can receive the audio signal from the commerce server and direct the audio signal to the processor 270. The processor 270 can then control the speaker 282 to emit the audio content.

The direction sensor 284 can be configured to generate a direction signal that is indicative of the direction that the consumer is facing. The direction signal can be processed by the processor 270 or by the commerce server. For example, the direction sensor 284 can electrically communicate the direction signal containing direction data to the processor 270 and the processor 270 can control the transmitter 278 to transmit the direction signal to the commerce server through the network. By way of example and not limitation, the direction signal can be useful in determining the identity of a product(s) visible in the video signal, as well as the location of the consumer within the retail store.

The direction sensor 284 can include a compass or another structure for deriving direction data. For example, the direction sensor 284 can include one or more Hall effect sensors. A Hall effect sensor is a transducer that varies its output voltage in response to a magnetic field. For example, the sensor operates as an analog transducer, directly returning a voltage. With a known magnetic field, its distance from the Hall plate can be determined. Using a group of sensors disposing about a periphery of a rotatable magnetic needle, the relative position of one end of the needle about the periphery can be deduced. It is noted that Hall effect sensors can be applied in other sensors of the head mountable unit.

The position sensor 286 can be configured to generate a position signal indicative of the position of the consumer within the retail store. The position sensor 286 can be configured to detect an absolute or relative position of the consumer wearing the head mountable unit. The position sensor 286 can electrically communicate a position signal containing position data to the processor 270 and the processor 270 can control the transmitter 278 to transmit the position signal to the commerce server through the network.

Identifying the position of the consumer can be accomplished by radio, ultrasound or ultrasonic, infrared, or any combination thereof. The position sensor 286 can be a component of a real-time locating system (RTLS), which is used to identify the location of objects and people in real time within a building such as a retail store. The position sensor 286 can include a tag that communicates with fixed reference points in the retail store. The fixed reference points can receive wireless signals from the position sensor 286. The position signal can be processed to assist in determining one or more products that are proximate to the consumer and are visible in the video signal.

The orientation sensor 288 can be configured to generate an orientation signal indicative of the orientation of the consumer's head, such as the extent to which the consumer is looking downward, upward, or parallel to the ground. A gyroscope can be a component of the orientation sensor 288. The orientation sensor 288 can generate the orientation signal in response to the orientation that is detected and communicate the orientation signal to the processor 270. The orientation of the consumer's head can indicate whether the consumer is viewing a lower shelf, an upper shelf, or a middle shelf.

The accelerometer 290 can be configured to generate an acceleration signal indicative of the motion of the consumer. The acceleration signal can be processed to assist in determining if the consumer has slowed or stopped, tending to indicate that the consumer is evaluating one or more products for purchase. The accelerometer 290 can be a sensor that is operable to detect the motion of the consumer wearing the head mountable unit. The accelerometer 290 can generate a signal based on the movement that is detected and communicate the signal to the processor 270. The motion that is detected can be the acceleration of the consumer and the processor 270 can derive the velocity of the consumer from the acceleration. Alternatively, the commerce server can process the acceleration signal to derive the velocity and acceleration of the consumer in the retail store.

The proximity sensor 292 can be operable to detect the presence of nearby objects without any physical contact. The proximity sensor 292 can apply an electromagnetic field or a beam of electromagnetic radiation such infrared and assess changes in the field or in the return signal. Alternatively, the proximity sensor 292 can apply capacitive photoelectric principles or induction. The proximity sensor 292 can generate a proximity signal and communicate the proximity signal to the processor 270. The proximity sensor 292 can be useful in determining when a consumer has grasped and is inspecting a product.

The distance sensor 294 can be operable to detect a distance between an object and the head mount unit. The distance sensor 294 can generate a distance signal and communicate the signal to the processor 270. The distance sensor 294 can apply a laser to determine distance. The direction of the laser can be aligned with the direction that the consumer is facing. The distance signal can be useful in determining the distance to an object in the video signal generated by one of the cameras 272, which can be useful in determining the consumer's location in the retail store.

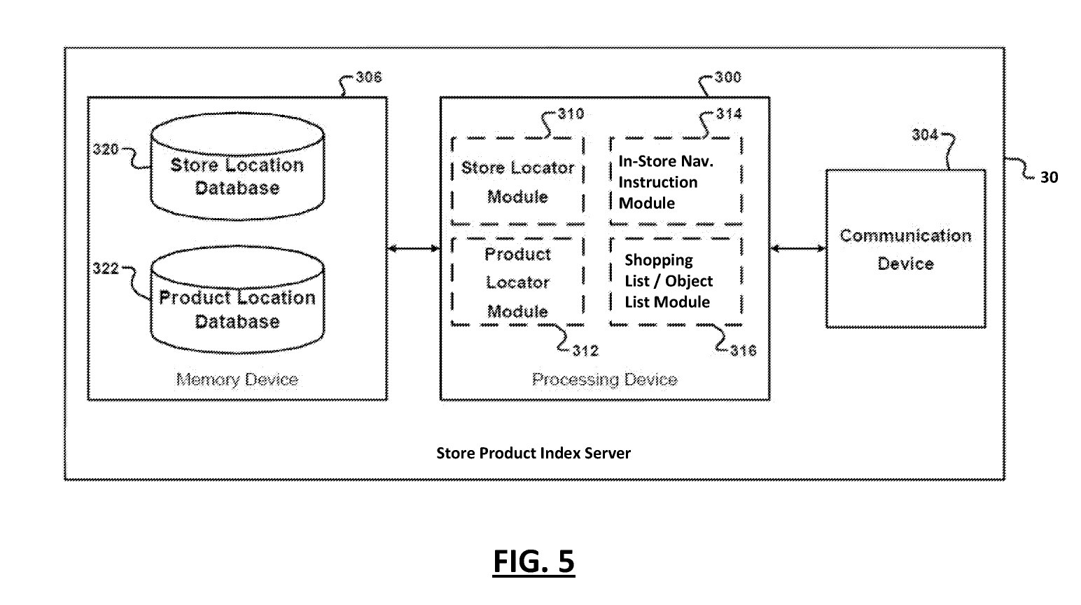

FIG. 5 is a schematic illustrating an exemplary store product index server. In the illustrated embodiment, the store product index server 30 may include a processing device 300, a communication device 304, and memory device 306.

The processing device 300 can include memory, e.g., read only memory (ROM) and random access memory (RAM), storing processor-executable instructions and one or more processors that execute the processor-executable instructions. In embodiments where the processing device 300 includes two or more processors, the processors can operate in a parallel or distributed manner. In the illustrative embodiment, the processing device 300 executes one or more of a store locator module 310, a product locator module 312, a in-store navigation instruction module 314, and a shopping list/object list module 316.

The communication device 304 is a device that allows the store product index server 30 to communicate with another device, e.g., the portable computerized device 50, via the network 20. The communication device 304 can include one or more wireless transceivers for performing wireless communication and/or one or more communication ports for performing wired communication.

The memory device 306 is a device that stores data generated or received by the store product index server 30. The memory device 306 can include, but is not limited to a hard disc drive, an optical disc drive, and/or a flash memory drive. Further, the memory device 306 may be distributed and located at multiple locations. The memory device 306 is accessible to the processing device 300. In some embodiments, the memory device 306 stores a store location database 320 and a product location database 322.

In some embodiments, the store location database 320 can store the store locations of one or more stores operated or associated with a retailer. The store location database 320 may be queried using a specific location, e.g., GPS coordinates, or a general location, e.g., postal zip code or city/state, and can return one or more stores that are proximate to the specific or general location. The store location database 320 may further be configured to store maps corresponding to each store location. The store location database 320 may be queried with a store location and can return the store map corresponding to the store location.

In some embodiments, the product location database 322 stores product waypoints indicating locations of the products sold by a retailer in the one or more stores operated or associated with the retailer. For example, the product location database 322 may store the location of “milk” in each of the stores operated or associated with the retailer. The product location database 322 may be queried with the item “milk” and a specific store location, and may return a waypoint indicating the location of “milk” at the specific store location.

The product location database 322 may be configured to store waypoints for specific products and generic products. For example, the product location database 322 may be configured to store waypoints indicating the location of “ice cream,” a generic product, and the location of “BEN AND JERRY'S® ice cream,” a specific product. It should be noted that a waypoint corresponding to a generic product or specific product may be represented using a starting location and ending location. For example, a waypoint corresponding to “ice cream” may indicate where the ice cream section begins and where the “ice cream” section ends. Similarly, a waypoint corresponding to “BEN AND JERRY'S® ice cream” may indicate where the BEN AND JERRY'S® ice cream begins and ends. It should be appreciated that when a specific product is a species of a generic product, e.g., BEN AND JERRY'S® ice cream is a species of “ice cream,” the waypoint corresponding to a specific product may be wholly contained within the waypoint corresponding to the generic product. In some embodiments, a generic product may be located in more than one location in the store. For example, milk may be located in the dairy section, while organic milk may be located in the natural foods location. In this type of scenario, the product location database 322 may store more than one location for milk. When such a situation arises, the product locator module 312 may retrieve multiple product waypoints, such that the multiple waypoints corresponding to the generic product are provided to the portable computerized device 50. An in-game graphic may, for example, highlight an entire region defined by a series of waypoints for a particular object being sought (the whole area in front of the ice cream cooler) or a single point in front of a particular product (the BEN AND JERRY'S® ice cream section.)

The product location database 322 may further store a type of each product sold by the retailer, e.g., groceries, home decor, and personal goods, and/or a section of the product, e.g., dairy or men's clothing. Furthermore, the types and/or sections can be stored relative to each store location. In this way, the product location database 322 can be queried with a store location and a product and can return a type of the product and/or a section of the product at the store location.

As discussed, the processing device 300 may execute the store locator module 310. The store locator module 310 receives a location from the portable computerized device 50 and determines one or more store locations corresponding to the received location. In some embodiments, the store locator module 310 queries the store location database 320 with the received location and receives one or more store locations that correspond to the received location. For example, the store location database 320 may return any store locations that are within a predetermined distance, e.g., 10 miles, from the received location. When more than one store location is received, the store locator module 310 may automatically select the store location nearest to the received location or may provide the store locations to the portable computerized device 50, thereby allowing the portable computerized device 50 or the user to select the store location.

The product locator module 312 receives an object being sought and determined a location in the store or a set of waypoints in the store associated with the object being sought. Product locator module 312 can provide the object location to in-store navigation instruction module 314 such that instructions can be provided to the child playing the game regarding how to get to or get closer to the location of the object being sought. In-store navigation instruction module 314 can include a store map/contextual rules for providing navigation instructions, for example, directing a child to go around the end of an aisle to get to the next aisle or preventing the child from being directed to walk behind a delicatessen counter to get to the next location. In-store navigation instruction module 314 can additionally provide a provide the rendered image of the store map to the portable computerized device 50, for example, with details showing the location of the adult and of the children playing the game in the context of the store map.

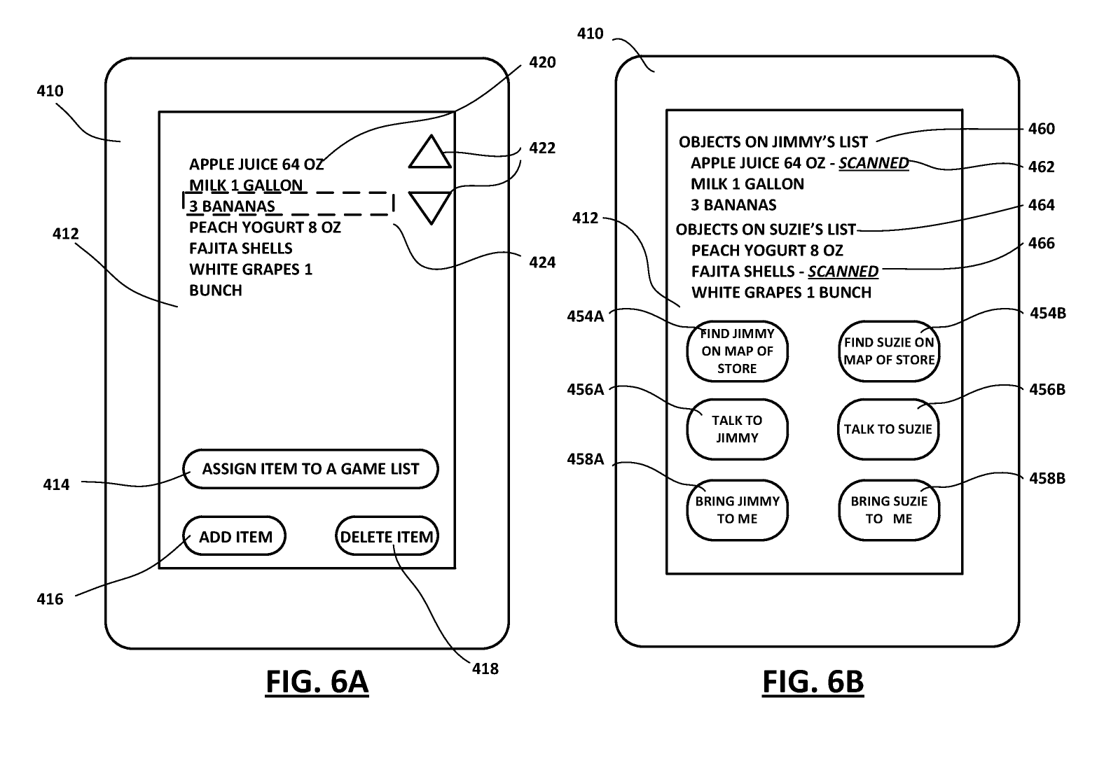

FIGS. 6A and 6B are schematics illustrating an exemplary portable computerized device configured to operate as a controller device for a scavenger hunt game. Device 410 includes an exemplary tablet computer device including display screen 412. FIG. 6A is a schematic illustrating the portable computerized device enabling a user to configure a shopping list and assign items on the shopping list to be assigned to objects lists for use in the game. In FIG. 6A, device 410 is configured to receive a shopping list from an adult planning a trip to a retail store. Button graphics 416 and 418 are provided as GUIs, permitting a user to, respectively, add and delete items from the shopping list. Adding items can be accomplished according to a number of methods. Prior to entry of the list, a particular store for the shopping trip can be selected. Upon the user touching button 416, a keyboard of buttons could be displayed, and text entered by the user could be compared with a database of products available at the store, permitting selection of particular items from the inventory of the store. In another embodiment, a circular with items on sale at the store could be presented for selection. In another embodiment, historical lists of the adult can be used to select products for the current list. In another embodiment, a selectable list of products can be presented, wherein broad categories are narrowed (e.g., FOOD-->PRODUCE-->VEGETABLES-->CUCUMBERS-->ORGANIC CUCUMBER.) A number of methods to select products for the shopping list are envisioned. List 420 is illustrated including a number of selected products that can be assigned as objects to be sought. Arrows 422 are provided for navigating a long list. Item 424 is shown with a graphic indicated selection of “3 bananas” from the list. Based upon this selection of item 424, the item can be deleted or assigned to a particular list of items to be sought for a child.

FIG. 6B is a schematic illustrating the portable computerized device enabling a user to monitor a plurality of children during operation of the game, to monitor progress of items from the shopping list being acquired, and to communicate with the children as desired. List 460 illustrates objects being sought by a first child, and list 464 illustrates objects being sought by a second child. Lists 460 and 464 can be toggled to fit the whole screen or be fit to a portion of the screen to permit a series of buttons for control of the game and interaction with the children playing the game. For longer lists, arrows similar to arrows 422 could be used to scroll along the lists. In FIG. 6B, a series of graphical buttons are projected. Buttons 454A and 454B permit the adult to see a representation of the children's locations on a map of the store. Buttons 456A and 456B permit the adult to communicate with either child. Communication can be through audio only, audio and visual, or text only. Buttons 458A and 458B permit the adult to terminate instructions to the children to find objects being sought and instead show instructions to the children to return to the adult. A number of buttons and commands are envisioned for use on the controller device, and the disclosure is not intended to be limited to the particular examples provided herein.

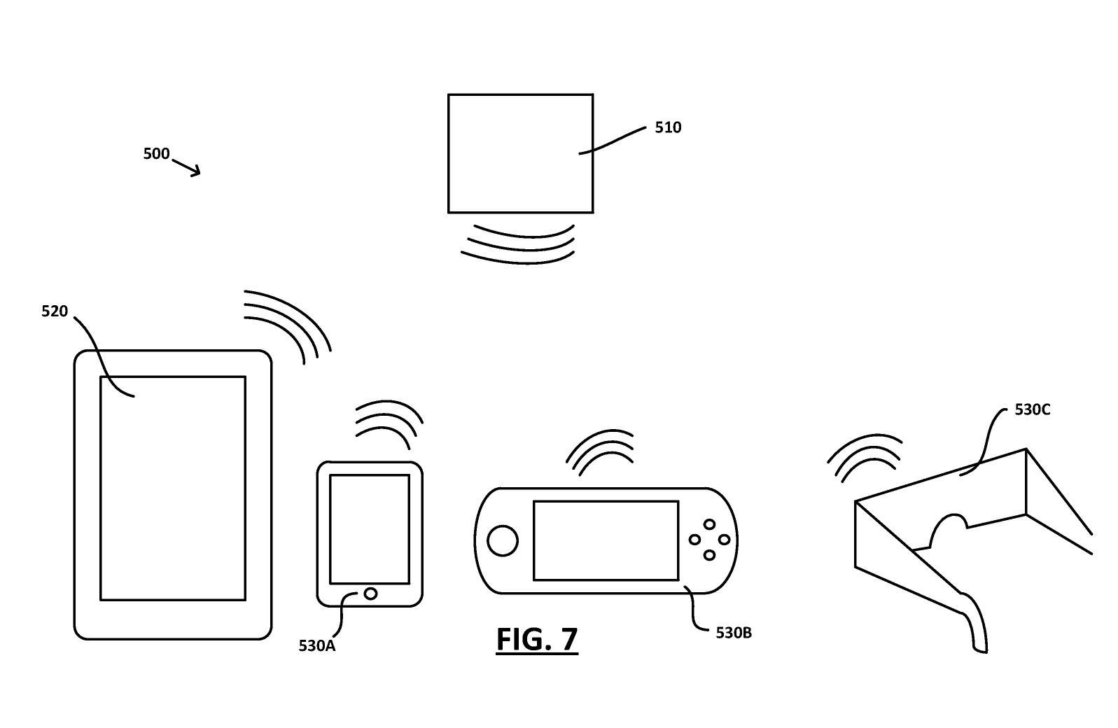

FIG. 7 is a schematic illustrating an exemplary controller device and a plurality of exemplary playing devices in communication with a store product index server. Configuration 500 includes a store product index server 510, for example, located in a store and providing a local wireless connection point. Each of controller device 520, embodied as a tablet computer, and three playing devices 530A, embodied as a smart-phone, 530B, embodied as a gaming device, and 530C, embodied as eyeglasses configured to project images upon a user's view, are illustrated in wireless communication with server 510. Configuration 500 is configured to operate the scavenger hunt methods disclosed herein, wherein each of devices 520, 530A, 530B, and 530C are configured to provide a communication signal with and through server 510. In another embodiment, the devices can be configured to communicate directly with each other.

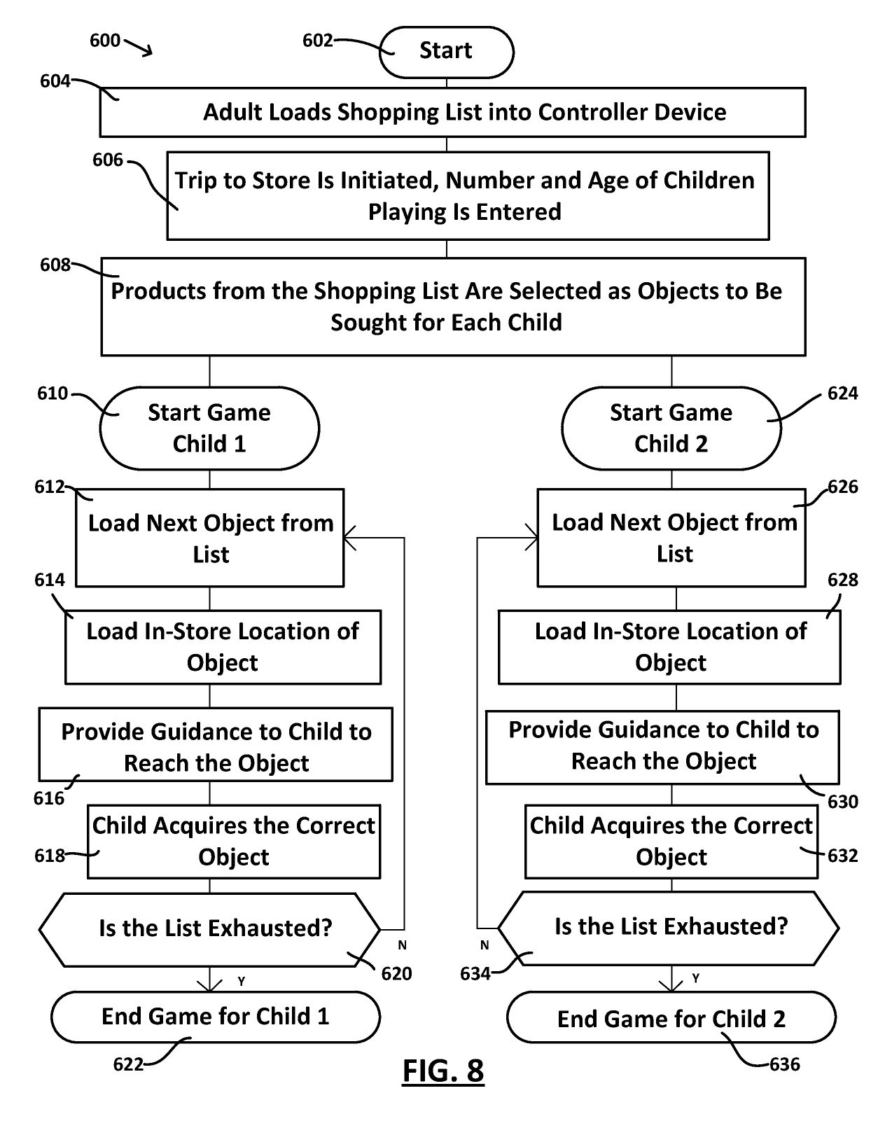

FIG. 8 is a flowchart illustrating an exemplary process to operate a scavenger hunt game with two children. Process 600 begins at step 602. At step 604, an adult loads a shopping list into a controller device. At step 606, a trip to a particular store is initiated, and information related to the trip including a number and age of particular children going to the store and desiring to play the game is entered. At step 608, products from the shopping list are selected and assigned as objects to be sought for each of the children playing the game. Steps 610-622 illustrate a first child playing the game at the store, and steps 624-636 illustrate a second child playing the game at the store. At step 610, the first child starts the game. At step 612, the playing device of the first child loads a next object from a list of objects to be sought. At step 614, an in-store location is loaded for the object loaded in step 612. In step 616, guidance is provided to the child to reach the object according to methods disclosed herein. At step 618, the child acquires the correct object corresponding to the object begin sought. At step 620, a determination is made whether the list of objects to be sought is exhausted. If it is not exhausted, the game for the first child returns to step 612 and a next object to be sought is loaded. If the list of object to be sought is exhausted at step 620, the game for the first child is ended at step 622. At step 624, the second child starts the game in parallel with the first child starting the game. At step 626, the playing device of the second child loads a next object from a list of objects to be sought. At step 628, an in-store location is loaded for the object loaded in step 626. In step 630, guidance is provided to the child to reach the object according to methods disclosed herein. At step 632, the child acquires the correct object corresponding to the object begin sought. At step 634, a determination is made whether the list of objects to be sought for the second child is exhausted. If it is not exhausted, the game for the second child returns to step 626 and a next object to be sought is loaded. If the list of object to be sought is exhausted at step 634, the game for the second child is ended at step 636.

According to one embodiment, objects are assigned to a list of objects to be sought at the outset of a game. In another embodiment, objects can be assigned to the list as the game progresses. According to one embodiment, objects can be assigned one at a time until the shopping list is exhausted. In this way, if one child is retrieving items much more quickly than other children, the list will be exhausted more quickly. In another embodiment, objects can be assigned based upon the location of the child in the store at the time the object is assigned. A closest remaining object can be assigned to the child to make the overall distance traveled smaller, thereby speeding progression of the game. A furthest remaining object can be assigned to draw the game out and make the finding of the next object more interesting for the child. A game can be operated wherein objects being sought are provided sequentially or with one object being available for in-store navigation instructions at a time. In another embodiment, a game can be operated wherein all items on a list are concurrently available to the player, and, for example, as the child walks through the store, a display and/or a sound are activated and modulated as the child gets within 30 feet of one of the objects being sought.

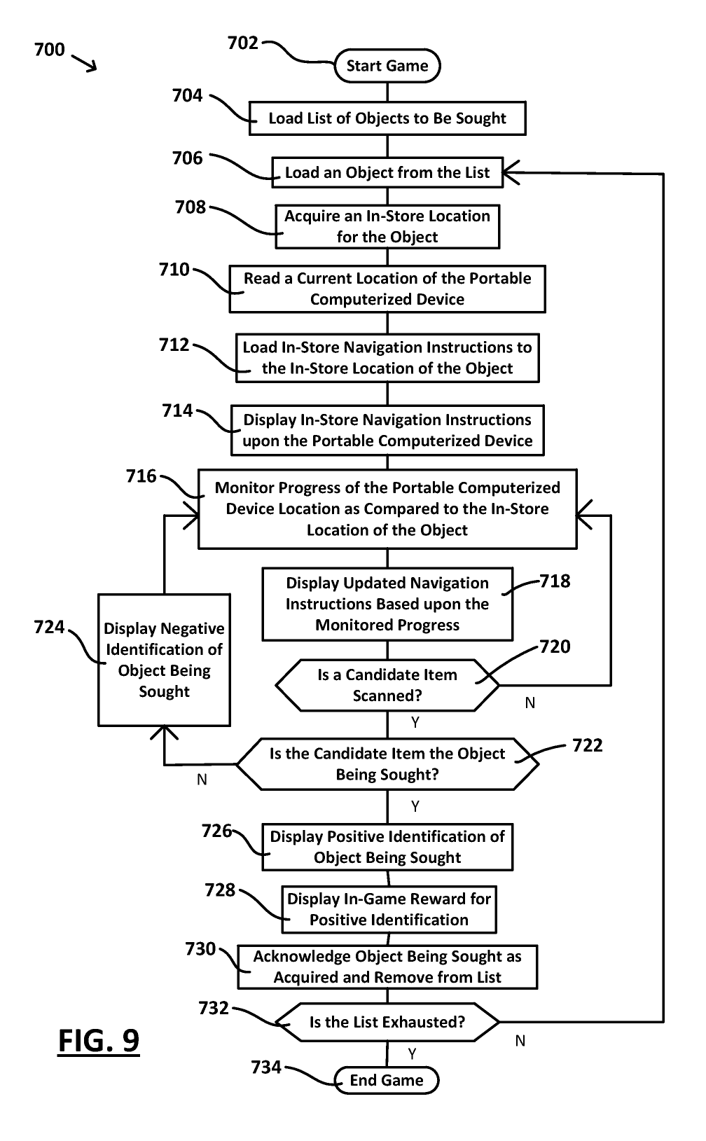

FIG. 9 is a flowchart illustrating exemplary operation of a playing device guiding a child through a scavenger hunt game according to some embodiments of the disclosure. Process 700 starts at step 702. At step 704, a list of objects to be sough is loaded onto the child's playing device. At step 706, an object is loaded from the list of objects to be sought. At step 708, an in-store location for the object being sought is acquired. At step 710, a current location of the playing device is read, for example, based upon a GPS reading. At step 712, in-store navigation instructions are loaded to guide the child from the current location to the location of the object being sought. At step 714, the instructions loaded in step 712 are displayed upon the playing device. At step 716, progress of the playing device location as compared to the in-store location of the object is monitored. In step 718, updated navigation instructions are displayed based upon the monitored progress. At step 720, a determination is made whether an object has been scanned by the child as a candidate object. If not object has been scanned as a candidate object, the process returns to step 716 and progress of the playing device toward the location of the object being sought is continued to be monitored. If an object is scanned as a candidate object, then the process advances to step 722 whereat the candidate object is compared to the object being sought. If the candidate object is determined to not be the object being sought, the process advances to step 724 whereat a negative identification of the object being sought is displayed and the process returns to step 716. If the candidate object is determined to be the object being sought, the process advances to step 726 whereat a positive identification of the object being sought is displayed. Applying rules of the game being played, if positive identification of the object being sought merits an in-game reward, step 728 displays the in-game reward for the child. At step 730, the list of items being sought is updated by removing the item that has been retrieved. At step 732, a determination is made whether the list of items being sought is exhausted. If the list is not exhausted, the process returns to step 706. If the list is exhausted, then the game ends at step 734. A number of different configurations, options, and game rules are envisioned. The processes of FIGS. 8 and 9 are provided as non-exhaustive examples of how an augmented reality game might be operated upon a playing device or playing devices, but the disclosure is not intended to be limited to the particular exemplary embodiments provided herein.

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

What is claimed is:

1. A computer-implemented method comprising:
operating a scavenger hunt game within a retail store, comprising:
receiving, at a processing device, a list of objects being sought, each object indicating one of a product being sold by the store or a task to be performed within the store;
for each object being sought, determining an in-store location for the object;
displaying, at the processing device, though an augmented reality program in-store navigational instructions for each object being sought based upon the in-store location for the object; and
confirming, at the processing device, retrieval of each object being sought.

2. The computer-implemented method of claim 1, wherein the processing device comprises a first playing device; and
further comprising a second processing device comprising a controlling device.

3. The computer-implemented method of claim 2, further comprising providing, at the second processing device, one of
control of the list of objects being sought,
assignment of items to the list of objects being sought,
a monitored location of the first processing device,
the list of objects being sought,
a list of each of the objects retrieved,
a communication signal to the first processing device,
a communication signal from the first processing device, and
a command to instruct the first processing device to provide an instruction to return to the second processing device.

4. The computer-implemented method of claim 2, further comprising:
displaying, at a third processing device, in-store navigational instructions for objects from a second list of objects being sought; and
confirming, at the third processing device, retrieval of each object from the second list of objects being sought.

5. The computer-implemented method of claim 1, further comprising monitoring, at the processing device, a location of the processing device; and
wherein displaying the in-store navigational instructions is further based upon the location of the processing device.

6. The computer-implemented method of claim 1, wherein displaying the in-store navigational instructions for each object being sought is performed for one of the objects being sought at a time.

7. The computer-implemented method of claim 6, wherein displaying the in-store navigational instructions for each object being sought comprises:
monitoring a location of the processing device;
monitoring progress of the processing device toward the in-store location for the object being sought; and
displaying a message based upon the monitored progress.

8. The computer-implemented method of claim 7, wherein displaying the message based upon the monitored progress comprises:
displaying a message including the word “warmer” if the location of the processing device is getting closer to the in-store location of the object being sought over time; and
displaying a message including the word “colder” if the location of the processing device is getting farther from the in-store location of the object being sought over time.

9. The computer-implemented method of claim 1, wherein displaying the in-store navigational instructions for each object being sought is performed concurrently for a plurality of the objects being sought.

10. The computer-implemented method of claim 1, wherein displaying the in-store navigational instructions for each object being sought comprises displaying an arrow graphic pointing to a location within the store.

11. The computer-implemented method of claim 1, wherein displaying the in-store navigational instructions for each object being sought comprises highlighting a region on the ground of the store.

12. The computer-implemented method of claim 1, wherein displaying though the augmented reality program in-store navigational instructions for each object being sought comprises displaying the in-store navigational instructions upon eyeglasses configured to permit a wearer to see a view through the eyeglasses and to augment the view with projected graphics.

13. The computer-implemented method of claim 1, wherein displaying though the augmented reality program in-store navigational instructions for each object being sought comprises:
utilizing a portable computerized device equipped with a camera to capture a series of images of a view;
displaying the series of images of the view upon a display of the portable computerized device in real-time; and
enhancing the display with the in-store navigational instructions.

14. A server comprising:
a store locator module that determines a store location of a retailer whereat a planned shopping trip is to occur;
a product locator module configured to receive an electronic shopping list containing one or more items, each item indicating a product sold at the store location, and to provide an in-store location for each of the items;
an in-store navigation instruction module providing in-store navigation instructions at the store location for each of the items of the shopping list based upon the in-store location for each of the items; and
a shopping list/object list module configured to receive the electronic shopping list and provide a list of objects to be sought for operation of a scavenger hunt game at the store location, wherein operation of the scavenger hunt game is based upon the list of objects to be sought and the in-store navigation instructions; and
wherein the in-store navigation instructions are configured to be operated by a portable computerized device operating an augmented reality program.

15. The server of claim 14, wherein the in-store navigation instruction module receives through a communications network a location of the portable computerized device; and
wherein the in-store navigation instruction module providing in-store navigation instructions is further based upon the location of the portable computerized device.

16. A software application for operation of a scavenger hunt game within a retail store, the software application operating upon a portable computerized device, comprising:
receiving, at the portable computerized device, an object being sought indicating one of a product being sold by the store or a task to be performed within the store;
receiving, at the portable computerized device, a current location of the portable computerized device;
receiving, at the portable computerized device, in-store navigation instructions to proceed from the current location of the portable computerized device to an in-store location for the object being sought; and
displaying, at the processing device, though an augmented reality program the in-store navigational instructions upon a view of an area proximate to the processing device.

17. The software application of claim 16, further comprising:
referencing, at the portable computerized device, a product index of a candidate object;
comparing, at the portable computerized device, the product index to an expected index for the object being sought; and
provide, at the portable computerized device, a positive indication that the candidate object is the object being sought based upon the comparing.

18. The software application of claim 16, further comprising:
referencing, at the portable computerized device, a product index of a candidate object;
communicating, at the portable computerized device, the product index of the candidate object to a second portable computerized device; and
receiving, at the portable computerized device, approval of the candidate object as the object being sought.

19. The software application of claim 16, further comprising:
confirming, at the portable computerized device, retrieval of the object being sought; and
providing, at the portable computerized device, a reward for the retrieval.
